(19) United States
(12) Patent Application Publication
(10) Pub. No.: US 2009/0218148 A1
(43) Pub. Date: Sep. 3, 2009

(54) Detection of Attack Velocity Features in Capacitive Touch Sensor Data

(76) Inventors: Angela Beth Hugeback, Seattle, WA (US); Jeffrey Owen Snyder, New York, NY (US)

Correspondence Address: MERCHANT & GOULD PC, P.O. BOX 2903, MINNEAPOLIS, MN, 55402-0903, US

(21) Appl. No.: 12/394,170

(22) Filed: Feb. 27, 2009

Related U.S. Application Data
(60) Provisional application No. 61/032,205, filed on Feb. 28, 2008.

(51) Int. Cl. G08C 21/00

(52) U.S. Cl. 178/18.06

(57) ABSTRACT

Systems and methods for detecting attack velocity features from a single capacitive touch sensor or an array of capacitive touch sensors. In one example, the method uses sequential capacitive touch sensor data to estimate the velocity at which the sensor was touched.

### RELATED APPLICATION

This application claims the benefit of U.S. Patent Application Ser. No. 61/032,205 filed on Feb. 28, 2008, the entirety of which is hereby incorporated by reference.

### BACKGROUND

Capacitive touch sensors can be used to detect human contact with an electronic device. The output of the sensor is normally interpreted as a real-time stream of numeric values, often with a zero or low values indicating no human contact, and higher values indicating that more surface area of the skin is in contact with the device.

Capacitive touch sensors are frequently used in the construction of user interface devices such as touch screens. When a person touches the screen in a particular location, the capacitive touch sensors register this contact. The sensor output is sent to a computing chip or device which can then take a specified action based on the detected human input. For example, capacitive touch sensors can be used to detect the moment at which human contact with the device occurs, the location of that contact, and the level of surface area contact that is present.

### SUMMARY

In one aspect, sequential capacitive touch sensor data is used to estimate the attack velocity with which a user has touched a device. The ability to estimate attack velocity features provides an added dimension of input from the user. The approach described herein is unique in that it allows for the detection of attack velocity features using capacitive touch sensors.

### DESCRIPTION OF THE FIGURES

FIG. 1 shows an example method for estimating attack velocity.

FIG. 2 shows another example method for estimating attack velocity.

FIG. 3 shows an example method for programming a capacitive touch sensing device.

FIG. 4 shows an example system for detecting attack velocity.

FIG. 5 shows another example system for detecting attack velocity.

### DETAILED DESCRIPTION

Example embodiments described herein relate to estimating attack velocity features from capacitive touch sensor data which allows for an additional dimension of user input for capacitive touch sensor based devices. This technique uses a sequence of capacitive touch sensor output values in order to estimate the attack velocity with which a user has touched a given device.

The system attempts to discern to the force with which a user taps or touches the capacitive touch-sensing device. More specifically, it is sensing the speed at which the sensor went from a “not-touched” state to a “touched” state. In the example application of a musical instrument, this speed is often referred to as the attack velocity, traditionally (though not exclusively) in relation to a piano or electronic music keyboard. In a keyboard instrument, when a user presses a key with more force, the key will move from its “up state” to its “down state” faster. In an acoustic instrument like a piano, this increased attack speed causes a hammer to strike a string with greater force. In an electronic musical keyboard, which often attempts to simulate the response of a piano, the motion of the key mechanism is sensed, and the calculation of the speed at which the key moved becomes (in the case of a MIDI compatible device) a velocity value. This velocity value is usually mapped to control the amplitude of the resulting sound, since this mapping produces the familiar result of a faster key-press resulting in a louder note. In the case of capacitive touch-sensing devices, there are often no moving parts for the keys of an instrument or switches of a human-input device. The interface is often a flat surface that senses a change in capacitance when a finger or other capacitive object comes near or in contact with it. The present disclosure relates to inferring attack velocity data from capacitance changes, without necessitating the use of moving parts, strain gauges or other pressure sensors.

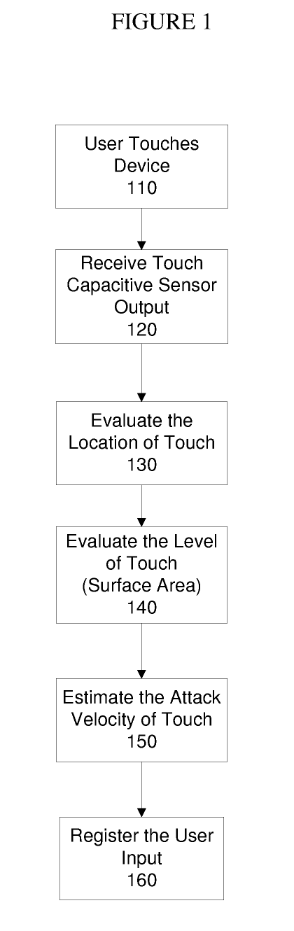

Referring to FIG. 1, an example method for estimating the attack velocity is shown. Initially, the user touches the device at operation 110, resulting in output from the capacitive touch sensor(s) 120 at operation 120. The features of location of touch and amount of capacitive input (a proxy to the amount of surface area on the sensor that is covered by the user's finger) are then evaluated at operations 130, 140 from the capacitive touch sensor(s) output values. Another feature that is evaluated is the attack velocity at operation 150, which is estimated from a sequential stream of the output values resulting from the capacitive touch sensor(s) starting from the moment when the user touches the device. The measured features can then be interpreted as the user's input at operation 160.

Often the output from a capacitive touch sensor must be thresholded because the sensor may output low non-zero levels even when it is not being touched. Low levels that do not surpass a given threshold can be interpreted as noise and can be converted to zeros, so that in order for a positive output value to register as user input the sensor must output values beyond that threshold. Herein, a non-zero output value will refer to an output value that does not meet the required threshold level to be interpreted as actual human contact.

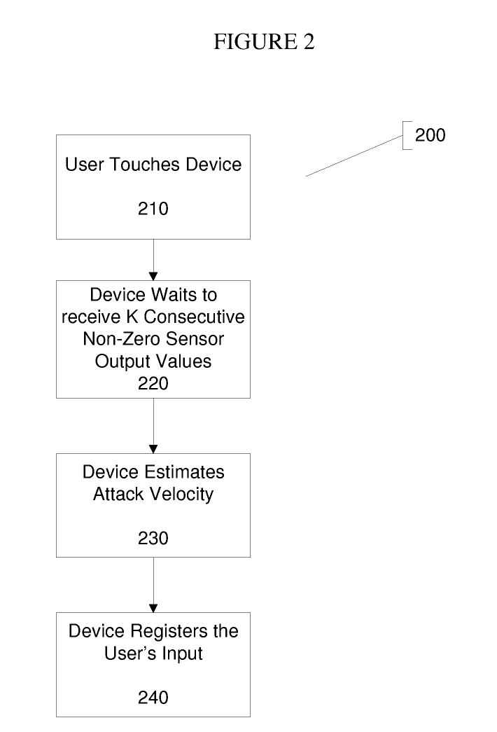

Referring now to FIG. 2, an example method 200 for estimating the attack velocity is shown. Initially, the user touches the device at operation 210, which initiates a string of non-zero output values coming from the capacitive touch sensor(s). The device waits until it has received K consecutive non-zero output values at operation 220 from the capacitive touch sensor(s), where K is a fixed integer-valued parameter. Once the K consecutive non-zero output values have been received, the computational component of the device estimates the attack velocity at operation 230 based on that stream of K output values. The estimate of attack velocity can then be interpreted as a component of the user's input at operation 240.

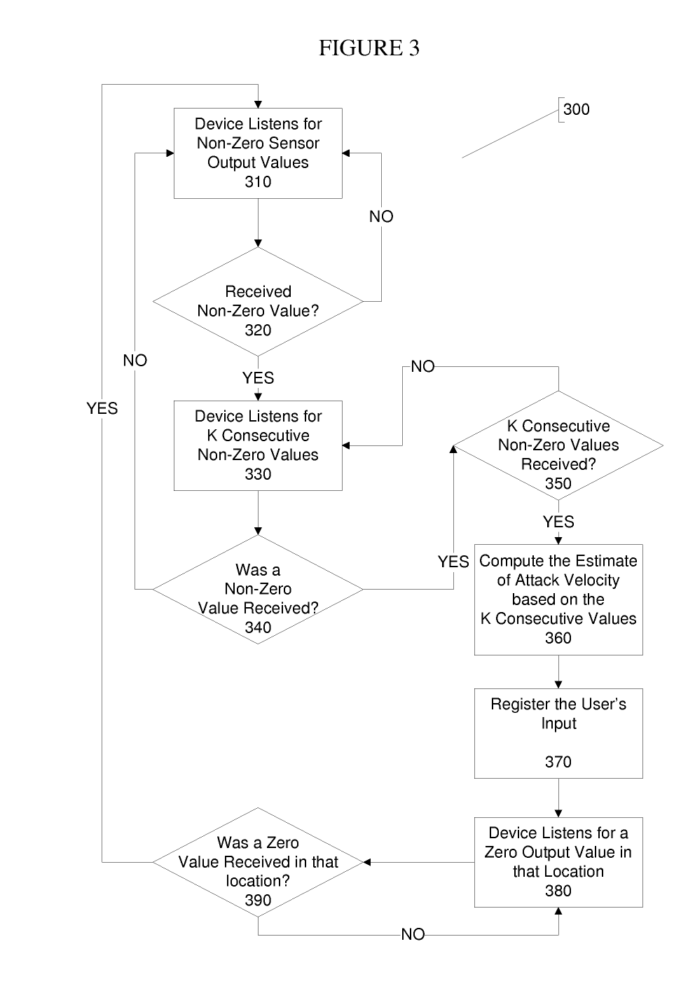

Referring now to FIG. 3, an example method 300 is shown for programming a capacitive touch sensing device to detect attack velocity features. At operation 310, the device listens for any non-zero output values from the capacitive touch sensor(s). A determination of whether or not a non-zero value is received is then made at operation 320. If a non-zero output value is received, control is passed to operation 330, and the device will listen to receive K non-zero consecutive output values. If at any time during the period in which the device is listening for the K consecutive non-zero output values (320 or 340) a zero value is received, then control is passed back to operation 310, and the device will once again listen for a first non-zero output value. If K consecutive non-zero values are received, then control is passed to operation 360, where the attack velocity is estimated from those K output values. Control is then passed to operation 370, where the attack velocity can be estimated as a component of the user's input. Control is then passed to operation 380, where the device listens until the first zero output value is received for the specific sensor or sensors that had been activated. Once a zero value is received, control is passed back to operation 310, where the device is reset to wait for the next non-zero sensor(s) output value. Note that this procedure can be implemented for an array of sensors (or locations on the input device) simultaneously.

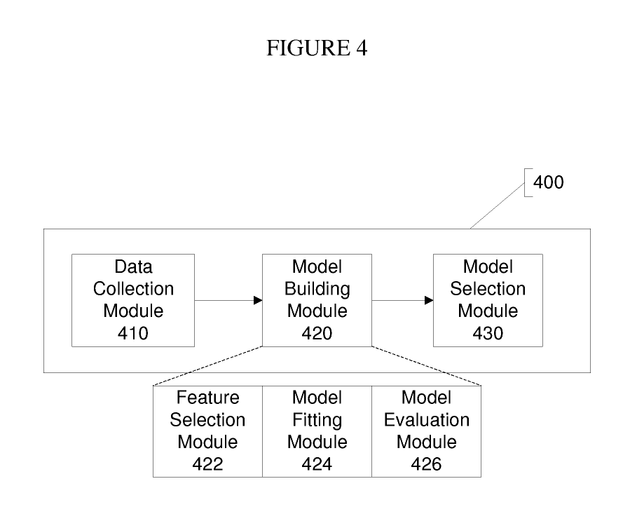

Referring now to FIG. 4, an example system 400 for detecting attack velocity features can include a data collection module 410, a modeling phase module 420, and a model selection module 430.

In the example shown, the data collection module 410 is programmed to collect user data under specified attack and finger configuration levels. Each sample of sequential touch capacitive output is labeled with a numerical or categorical (intended or true) attack value. The user data collected in the data collection module 410 can then be passed to the statistical modeling module 420.

The example statistical modeling module 420 includes a feature selection module 422, which is programmed to calculate various statistical and numerical features of the data for potential use in later statistical models. The statistical modeling module 420 also includes a model fitting module 424, which is programmed to construct statistical models from the statistical features formed in module 422. The statistical modeling module 420 also includes a model evaluation module 426, which is programmed to evaluate each of the statistical models formed in the model fitting module 424 for performance on test data.

The example model selection module 430 is programmed to select a final model (or collection of models) for implementation.

In example embodiments, the attack velocity can be estimated regardless of the overall degree of surface area touching the device (e.g., finger tip versus entire pad of the finger). This can be achieved by collecting training data for a variety of touch configurations. Also note that in examples with a smaller index K, there is a shorter time lag between the point at which the user touches a device and the point at which the device is able to calculate the attack velocity for the user's input.

In one example embodiment, the method of estimating attack velocity is used to add an attack velocity feature to an electronic musical controller called the Manta. The Manta is an interface for inputting expressive human control gestures into a computer. It includes 44 or 48 capacitive touch-sensors, laid out in a seven by six or eight by six hexagonal grid on a printed circuit board that is exposed to the user. The sensors are scanned sequentially by a microcontroller using the Sigma-Delta capacitive sensing technique employed by the Cypress Programmable System on Chip (PSoC). The microcontroller performs the necessary calculations and formats the data into two outputs per sensor:
1. A continuous value representing the current measured capacitance of that sensor which is updated every time the sensors are scanned.
2. An “attack velocity” value, representing an estimation of the attack velocity when that sensor switches state from “no touch sensed” to “touch sensed.”

This data is sent over USB to the user's host computer, where it can be used to control the parameters of sound synthesis, audio file playback, video mixing and effects, and other applications. A centroid detection algorithm may also be employed within the microcontroller, or on the host computer, to give the position and shape of objects that may be potentially larger than the user's finger, such as the user's hand.

In this example embodiment, data for the data collection module 410 is collected from the Manta, where each sample is created by touching one of the Manta's capacitive touch sensors and then collecting the subsequent stream of K non-zero output values produced by the capacitive touch sensor. In this example embodiment, only K=3 data points per sample were incorporated into the model for estimating attack velocity, although more or fewer data points can be used.

In this example embodiment, samples for the data collection module 410 are collected over five different levels of the attack velocity (recorded as level 1=soft through level 5=hard), and over two touch configurations (finger tip only and full finger pad). One hundred repetitions were collected for each of the ten configurations, resulting in a full data set of 1000 samples. Again, these parameters are illustrative only, and other levels, touch configurations, and numbers of repetitions can be used.

In this example embodiment, various sample-level numerical features are then constructed from the data in the feature selection module 422, as illustrated below. In this example, X1 denotes the first non-zero data point for a given sample, X2 denotes the second non-zero data point for that sample, and X3 denotes the third non-zero data point for that sample. The numerical features used in this example embodiment are:

LOG X1=log(X1)

LOG SUM=log(X1+X2+X3)

LOG AVGABSDIFF=log(1+(|X2−X1|+|X3−X2|)/2)

$$\begin{matrix}FIRSTDOWN = 1 , & if X 2 < X 1 \\ 2 , & if X 2 >= X 1 and X 3 < X 2 \\ 3 , & otherwise\end{matrix}$$

FIRSTDOWN1=Indicator {FIRSTDOWN==1}

UP1=Indicator {X2>X1}

UP2=Indicator {X3>X2}

DOWN1=Indicator {X2<X1}

DOWN2=Indicator {X3<X2}

UPDOWN=UP1+UP2−DOWN1−DOWN2

UPDOWN2=Indicator {UPDOWN==2}

In this example embodiment, various regression models are constructed in the model fitting module 424 using different combinations of the above features as well as additional numerical features as regressors, and each model is evaluated for performance against test data in the model evaluation module 426. In this example, the model selection module 430 results in the following final statistical model:

$$ATTACK = 4.73739 + - 4.00929 * FIRSTDOWN + 0.17864 * UPDOWN + - 0.05496 * LOG SUM * LOG X 1 + 0.78906 * FIRSTDOWN * LOG SUM + 0.49639 * LOG AVG ABS DIFF * FIRSTDOWN 1 + - 0.29711 * LOG AVG ABS DIFF * UPDOWN 2$$

In this example embodiment, the selected statistical model is effective in estimating attack velocity. On random splits of the 1000 sample points into 90% train and 10% test, the selected fitted model constructed from the training portion of the data was 98.7% accurate to within one attack level (after rounding the predicted attack to the nearest integer value) when evaluated on the remaining test portion of the data, and 99.9% accurate to within two attack levels on the test data set.

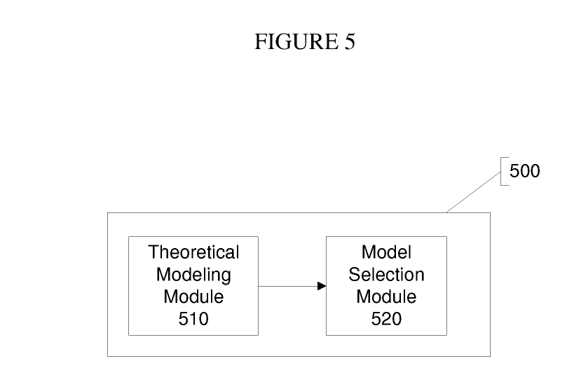

Referring now to FIG. 5, another example system 500 for detecting attack velocity features can include a theoretical modeling module 510 and a model selection module 520. The system 500 is similar to the system 400 except that the system 500 is programmed to take a theoretical approach to the problem rather than training a model on real data. In the theoretical modeling module 510, various theoretical models for the relationship between attack velocity and sequential touch capacitive sensor output are constructed. In the model selection module 520, a final theoretical model (or collection of models) is selected for implementation.

There are endless applications in industry in which the ability to estimate attack velocity features would be useful. For example, if sequential data is used to estimate attack velocity for a touch screen interface, then the user can indicate different intentions by touching the screen with varying levels of velocity (along a spectrum from touching softly to touching with force). The ability to estimate attack velocity can also be useful in capacitive touch sensing electronic musical instruments, because it allows the musician to vary their musical attack by touching the device with varying levels of force just as he or she would when playing an acoustic instrument such as the piano.

The various embodiments described above are provided by way of illustration only and should not be construed to limiting. Those skilled in the art will readily recognize various modifications and changes that may be made to the embodiments described above without departing from the true spirit and scope of the disclosure.

What is claimed is:

1. A method for estimating attack velocity, the method comprising:
providing a surface that is configured to allow a user to touch the surface;
receiving output from a capacitive touch sensor coupled to the surface when the user touches the surface;
estimating an attack velocity from a sequential stream of output values resulting from the capacitive touch sensor when the user touches the surface.

2. The method of claim 1, further comprising:
evaluating a location associated with the touch; and
evaluating a capacitive input associated with the touch.

3. The method of claim 1, wherein the estimating of the attack velocity further comprises waiting for a threshold number of non-zero output values from the capacitive touch sensor before estimating the attack velocity.

4. The method of claim 1, further comprising indicating one or more levels of intention of the user by estimating an intensity of the attack velocity.
